(19) United States
(12) Patent Application Publication
(10) Pub. No.: US 2010/0135246 A1
(43) Pub. Date: Jun. 3, 2010

(54) MOBILITY SOLUTION SELECTION FOR VOICE OVER EPS

(76) Inventor: Magnus Hallentål, Taby (SE)

Correspondence Address: ERICSSON INC., 6300 LEGACY DRIVE, M/S EVR 1-C-11, PLANO, TX, 75024, US

(21) Appl. No.: 12/562,806

(22) Filed: Sep. 18, 2009

Related U.S. Application Data
(60) Provisional application No. 61/105,623, filed on Oct. 15, 2008.

(51) Int. Cl. H04W 36/00; H04L 12/66

(52) U.S. Cl. 370/331; 370/352

(57) ABSTRACT

A method and apparatus for determining handover (HO) signaling in a communications network. The method of the present invention examines the International Mobile Subscriber Identity (IMSI) of a user equipment (UE) during HO and, based on the examination, determines whether Single Radio Voice Call Continuity (SRVCC) or circuit switched (CS) over Long Term Evolution (LTE) using a Generic Access Network Controller (GANC) should be used in the HO.

### CROSS-REFERENCE TO RELATED APPLICATIONS

This application claims the benefit of U.S. Provisional Application No. 61/105,623, filed Oct. 15, 2008, the disclosure of which is incorporated herein by reference.

### TECHNICAL FIELD

Aspects of the invention relate to the field of wireless telecommunications.

### BACKGROUND OF THE INVENTION

As used herein, the following abbreviations shall have the following meanings:

3GPP Third Generation Partnership Project

ACM Address Complete Message

BSS Base Station Subsystem

CAMEL Customized Applications for Mobile networks Enhanced Logic

CDMA Code Division Multiple Access

CS Circuit Switched

DTM/PSHO Dual Transfer Mode/Packet Switched Handover

eNodeB Evolved Node B

EPS Evolved Packet System

E-UTRAN Evolved-UTRAN

GAN Generic Access Network

GANC GAN Controller

GBR Guaranteed Bit Rate

GERAN GSM EDGE Radio Access Network

GSM Global System for Mobile Communications

GW Gateway

HLR Home Location Register

HO Handover

HSS Home Subscriber Server

IMS IP Multimedia Subsystem

IAM Initial Address Message

IMSI International Mobile Subscriber Identity

IP Internet Protocol

ISDN Integrated Services Digital Network

ISUP ISDN User Part

LTE Long Term Evolution

MM Mobility Management

MME Mobility Management Entity

MMTel Multimedia Telephony

MSC Mobile Switching Center

MSISDN Mobile Station International Subscriber Directory Number

Non-GBR Non-Guaranteed Bit Rate

PS Packet Switched

QCI QoS Class Identifier

RAN Radio Access Network

RANAP Radio Access Network Application Part

S-GW Signaling Gateway

SDP Session Description Protocol

SES Send End Signal

SGSN Serving GPRS Support Node

SRVCC Single Radio Voice Call Continuity

STN-SR Station Transfer Number for SRVCC

UE User equipment

UMTS Universal Mobile Telecommunications System

UTRAN UMTS Radio Access Network

VCC Voice Call Continuity

VDN VCC Directory Number

VoIP Voice over Internet Protocol

VPLMN Visited Public Land Mobile Network

WCDMA Wideband CDMA

The 3rd Generation Partnership Project (3GPP) is a collaboration between groups of telecommunications associations, to make a globally applicable third generation (3G) mobile phone system specification within the scope of the International Mobile Telecommunications-2000 project of the International Telecommunication Union (ITU). 3GPP specifications are based on evolved Global System for Mobile Communications (GSM) specifications. 3GPP standardization encompasses Radio, Core Network and Service architecture. The project was established in December 1998.

System Architecture Evolution (SAE) is the core network architecture of 3GPP's future LTE wireless communication standard. SAE is the evolution of the GPRS Core Network, but with a simplified architecture, all IP Network, support for higher throughput and lower latency radio access networks (RANs) and support for, and mobility between, multiple heterogeneous RANs, including legacy systems as GPRS, but also non-3GPP systems such as WiMAX.

The main component of the SAE architecture is the Evolved Packet System (EPS). The EPS will be the equivalent of the GPRS networks via the Mobility Management Entity (MME), Serving Gateway and PDN Gateway subcomponents. The MME is the key control-node for the LTE access-network. The Serving Gateway routes and forwards user data packets, while also acting as an aggregation point for packet flows and a mobility anchor point for the user plane during most of the .inter-eNodeB handovers. The PDN Gateway provides connectivity from the UE to external packet data networks by being the point of exit and entry of traffic for the UE, and hence the highest mobility anchor point.

The 3GPP Specification provides different methods to support a voice service via EPS. One is IMS MMTel which may be required to use SRVCC if there is no VoIP over PS (radio) bearers in the entire wide area network. SRVCC supports IMS Voice with a mechanism to move from a packet LTE or WCDMA network to the GSM, WCDMA, or cdma2000 1xRTT access and support voice service using a CS bearer rather than a packet bearer which is the primary choice for an IMS based voice service.

Another method to support a voice service via EPS is CS fallback wherein the user has access to the voice service while being connected to the LTE access, but the voice service is provided by an access that has (native) support for a CS voice service, i.e. GSM, WCDMA, or cdma2000 1xRTT, i.e. the user is moved to these accesses from LTE when originating or terminating a CS call.

One industry proposal envisions tunneling CS service over IP using the GAN and SRVCC standard. This proposal has gather vendors and operators in a industry forum called VoLGA (Voice over LTE Via GAN).

The architecture 100 in which CS over LTE using GANC is performed is seen in FIG. 1. GANC is equivalent to VANC as used in the VoLGA forum. The term GANC is used below. To support hand-over (HO), the SRVCC mechanisms are re-used such that the UE 101 simulates the SRVCC capability.

To support CS over LTE using GANC (sometimes referred to as “CS over LTE” herein), the following E-UTRAN attach procedure, in addition to 3GPPP TS 23.401, is required. CS over LTE using GANC will use the SRVCC additions as follows:

In CS over LTE, the UE 101 includes the SRVCC capability indication as part of the UE network capability in its Attach Request message. A SRVCC capability indicator is used instead of a CS over LTE specific indicator, as no standard exists for CS over LTE using GANC. The MME 104 stores this information for what it believes to be used for SRVCC operation, but in fact is used for CS over LTE.

The eNodeB of the E-UTRAN will receive a UE SRVCC capability indication as part of UE radio capability or from the MME 104 depending on how the standard evolves.

If the subscriber is allowed to have SRVCC in the VPLMN then the HSS includes SRVCC STN-SR and MSISDN in the Insert Subscriber Data message to the MME in normal cases. However because CS over LTE might be proprietary solution only supported by a few vendors and operators, roaming outside home network with SRVCC indication will be, in normal cases, disallowed, thus only 2G and 3G will be allowed for roaming users.

To make the process work, the MME and eNodeB must accept that the UE is capable of the SRVCC solution. The eNodeB would signal that a certain HO request sent to the MME is an SRVCC HO or that the target cell capability does not support IMS Voice, or VoIP in general. The foregoing option has not yet been determined by 3GPP. The MME would use the information from the eNodeB, together with the terminal capability and subscription information downloaded from HSS during attach, to determine whether the SRVCC “bearer splitting function” and the Sv interface, both defined for SRVCC, are to be used to perform a PS to CS HO.

In 3GPP, the Sv interface in the SRVCC is between the MME and the MSC and in the industry initiative (VOLGA) the Sv interface 105 is re-used as an interface between the MME and a GANC as seen in FIG. 1.

FIG. 2 illustrates the HO procedure 200 for CS over LTE GANC solution re-using SRVCC procedures for a handover between CS over LTE to GSM. The procedures shows the case where the MSC connects to the GANC via an lu interface. The procedures are similar if the MSC connects to the GANC via an A interface):

Step 201. Based on UE measurement reports, the source E-UTRAN determines whether to trigger a handover to GERAN.

Step 202. The source E-UTRAN sends a Handover Required (Source to Target Transparent Container) message to the source MME. The E-UTRAN also indicates to the MME that this is a SRVCC HO operation. A SRVCC indicator is used as no CS over LTE indicator exists. Although the MME and eNodeB interpret this as SRVCC, it is a CS over LTE solution.

Step 203. Based on the QCI associated with the voice bearer (QCI 1 or similar depending on the determination of the 3GPP) and the SRVCC HO indication, the source MME splits the voice bearer from the non voice bearers and initiates the SRVCC handover procedure for the voice bearer by sending a Forward Relocation Request (VDN/MSISDN), Source to Target Transparent Container, MM Context message to the GANC. The MME receives the MSISDN from the HSS as part of the subscription profile downloaded during the E-UTRAN attach procedure. The MM Context contains security related information. The security related information will not be required if the GANC has that information. Note that VDN and MISDN may not be used by the GANC, as it is part of standard SRVCC procedure. The GANC discards the information.

Step 204. The GANC interworks the PS HO request with a RANAP Relocation Required over the lu interface to the MSC. GANC is regarded as the source RAN by the MSC. The CS Security key may need to be derived.

Step 205. The target MSC performs resource allocation with the target BSS by exchanging Handover Request/Acknowledge messages. If the Inter-MSC HO must be performed, normal inter-MSC procedures will be exchanged between the source MSC and target MSC.

Step 206. When resources have been allocated in BSS, the MSC sends a RANAP relocation command to the GANC.

Step 207. The GANC interworks the RANAP relocation command to a Forward Relocation Response (Target to Source Transparent Container) message which is sent to the source MME. The source MME acknowledges that at the end of the CS-PS handover the non-GBR bearers should be preserved.

Step 208a. The source MME sends a Handover Command (Target to Source Transparent Container) message to the source E-UTRAN. The message includes information about the voice component only.

Step 208b. In parallel to the previous step, the source MME exchanges Update Bearer Request/response messages with the Serving GW. The S1-U bearers are released for all EPS bearers and the voice bearer is deactivated. The non-GBR bearers are preserved. The MME is aware that a PS to CS handover has occurred due to SRVCC, so upon receipt of downlink data notification from the S-GW the MME shall not page the UE.

Step 209. Source E-UTRAN sends a HO from E-UTRAN Command message to the UE. There may be an indication to UE to inform PS to CS HO.

Step 210. HO Detection at the target BSS.

Step 211. The target BSS sends a HO Complete message to the target MSC.

Step 212. The MSC sends a RANAP release command to GANC.

Step 213. The RANAP is release complete.

Step 214. The GANC sends a Forward Relocation Complete message to the source MME, informing it that the UE has arrived on the target side. The source MME acknowledges the information by sending a Forward Relocation Complete Acknowledge message to the GANC.

Step 215. The call has moved over to CS

In standard SRVCC, the MME selects the MSC based on the target cell identity. Consequently the MME is unable to determine which node, an MSC or GANC, it should signal to use the Sv interface procedures if both, i.e. standard SRVCC and reuse of the STRVCC procedures for CS over LTE, are present in the network.

Hence, two problems occur: (1) it is not possible to have both methods in the network, because there is only one terminal capability (“SRVCC capable”) used for both methods and (2) a network cannot support SRVCC or the industry initiative solution to incoming roaming users, since the interpretation of the terminal capability (“SRVCC capable”) is ambiguous.

FIGS. 3 and 4 provide selected parts from 3GPP TS 23.216. FIG. 3 illustrates the SRVCC architecture 300 for E-UTRAN to 3GPP UTRAN/GERAN. FIG. 4 illustrates the steps 400 for SRVCC from E-UTRAN to GERAN without DTM/PSHO support. As seen therein:

Step 401. Based on UE measurement reports, the source E-UTRAN determines to trigger an SRVCC HO to GERAN.

Step 402. The source E-UTRAN sends Handover Required (Target ID, Source to Target. Transparent Container) message to the source MME. The E-UTRAN also indicates to the MME that this is a SRVCC HO operation.

Step 403. Based on the QCI associated with the voice bearer (QCI 1) and the SRVCC handover indication, the source MME splits the voice bearer from the non voice bearers and initiates the PS-CS HO procedure for the voice bearer only towards MSC Server.

Step 404. The MME sends a Forward Relocation Request (STN-SR, MSISDN, Source to Target Transparent Container, MM Context) message to the MSC server. The MSC server is selected based on the Target ID received in the Handover Required message. The MME receives the STN-SR and MS ISDN from the HSS as part of the subscription profile downloaded during the E-UTRAN attach procedure. The MM Context contains security related information. The CS security key is derived by the MME from the E-UTRAN/EPS domain key as defined in TS 33.401. The CS Security key is sent in the MM Context.

Step 405. The MSC Server interworks the PS-CS handover request with a CS inter MSC handover request by sending a Prepare Handover Request message to the target MSC.

Step 406. The target MSC performs resource allocation with the target BSS by exchanging Handover Request/Acknowledge messages.

Step 407. The target MSC sends a Prepare Handover Response message to the MSC Server.

Step 408. Establishing a circuit connection between the target MSC and the MGW associated with the MSC server e.g., using ISUP IAM and ACM messages.

Step 409. The MSC server initiates the Session Transfer by using the STN-SR, that is, by sending an ISUP IAM (STN-SR) message towards the IMS. Standard IMS Service Continuity procedures are applied for execution of the Session Transfer, as discussed in TS 23.292 and TS 23.237. During the execution of the Session Transfer procedure, the remote end is updated with the SDP of the CS access leg. The downlink flow of VoIP packets is switched towards the CS access leg at this point. Note, however, that if the MSC server is using an ISUP interface, then the initiation of the session transfer may fail if the subscriber profile including CAMEL triggers is not available prior HO (see clause 7.3.2.1 in TS 23.292 [13]).

Step 410. The MSC server sends a Forward Relocation Response (Target to Source Transparent Container) message to the source MME. The source MME preserves the non-GBR bearers at the end of the PS-CS HO.

Step 411. The source MME sends a HO Command (Target to Source Transparent Container) message to the source E-UTRAN. The message includes information about the voice component only.

Step 412. The source E-UTRAN sends a HO from E-UTRAN Command message to the UE.

Step 413. Handover Detection at the target BSS.

Step 414. The UE starts the Suspend procedure specified in TS 23.060 [10], clause 16.2.1.1.2. This triggers the Target SGSN to send a Suspend Request message to the Source MME. The MME returns a Suspend Response to the Target SGSN, which contains the MM and PDP contexts of the UE. The MME also starts the preservation of non-GBR bearers and the deactivation of the voice bearer.

Step 415. The target BSS sends a HO Complete message to the target MSC.

Step 416. The target MSC sends an SES (HO Complete) message to the MSC server.

Step 417. Completion of the establishment of the circuit connection between the MSC and the MGW associated with the MSC server is completed, e.g., with the target MSC sending ISUP Answer message to the MSC server.

Step 418. The MSC server sends a Forward Relocation Complete message to the source MME, informing it that the UE has arrived on the target side. The source MME acknowledges the information by sending a Forward Relocation Complete Acknowledge message to the MSC server.

Step 419. The MSC server may perform a MAP Update Location to the HSS/HLR if needed. This may be needed for MSC Server to receive GSM Supplementary Service information and routing of mobile terminating calls properly in certain configuration. Note, however, that this Update Location is not initiated by the UE.

After the CS voice call is terminated and if the UE is still in GERAN, then (as specified in TS 23.060 [10]) the UE shall resume PS services by sending a Routing Area Update Request message to the SGSN. The Update Type depends on the mode of operation of the GERAN network, e.g., in mode I, a Combined RA/LA Update is used and in mode II or III, a Routing Area Update is used.

### BRIEF SUMMARY OF THE INVENTION

The following presents a simplified summary of the invention in order to provide a basic understanding of some aspects of the invention. This summary is not an exhaustive overview of the invention. It is not intended to identify key or critical elements of the invention or to delineate the scope of the invention. Its sole purpose is to present some concepts in a simplified form as a prelude to the more detailed description that is discussed later. The present invention is directed to a new functional entity on the Sv interface that examines the IMSI during HO and, based on the examination, determines whether to use SRVCC or CS over LTE, using GAN.

### BRIEF DESCRIPTION OF THE SEVERAL VIEWS OF THE DRAWING

In the following section, the invention will be described with reference to exemplary embodiments illustrated in the figures, in which:

FIG. 1 illustrates the architecture for the industry initiative CS over LTE using GANC (in VoLGA GANC is replaced by the term VANC);

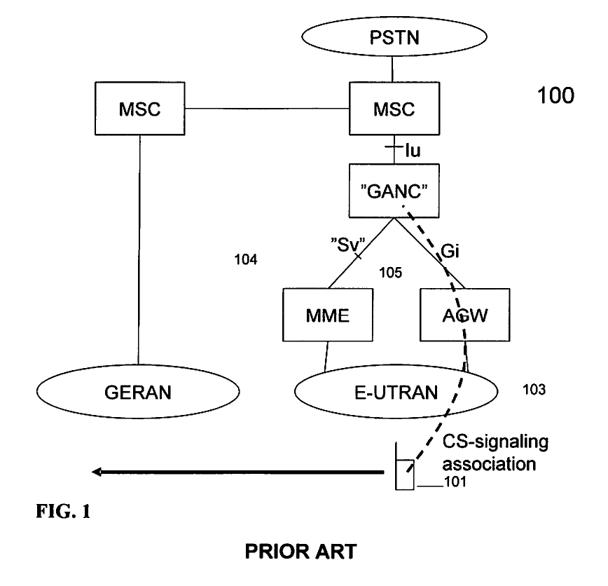

FIG. 2 illustrates how the HO procedure for CS over LTE GANC solution reusing SRVCC procedures for a handover between CS over LTE to GSM will work;

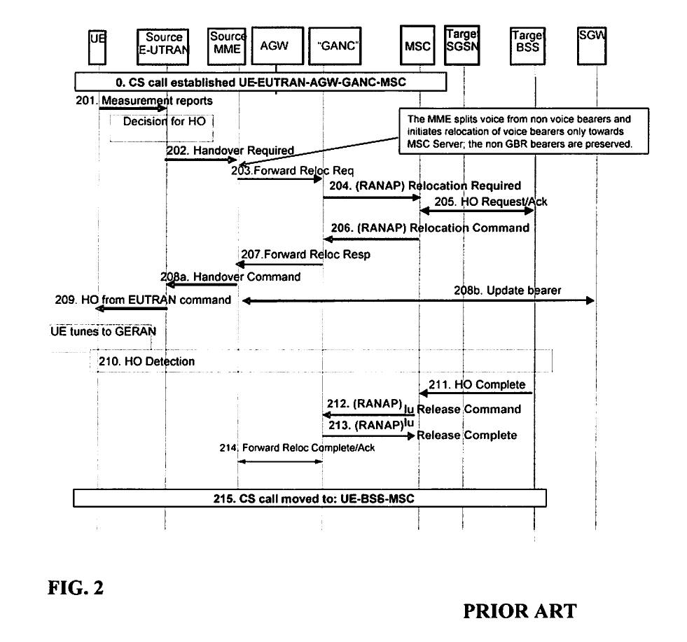

FIG. 3 illustrates the SRVCC architecture for E-UTRAN to 3GPP UTRAN/GERAN;

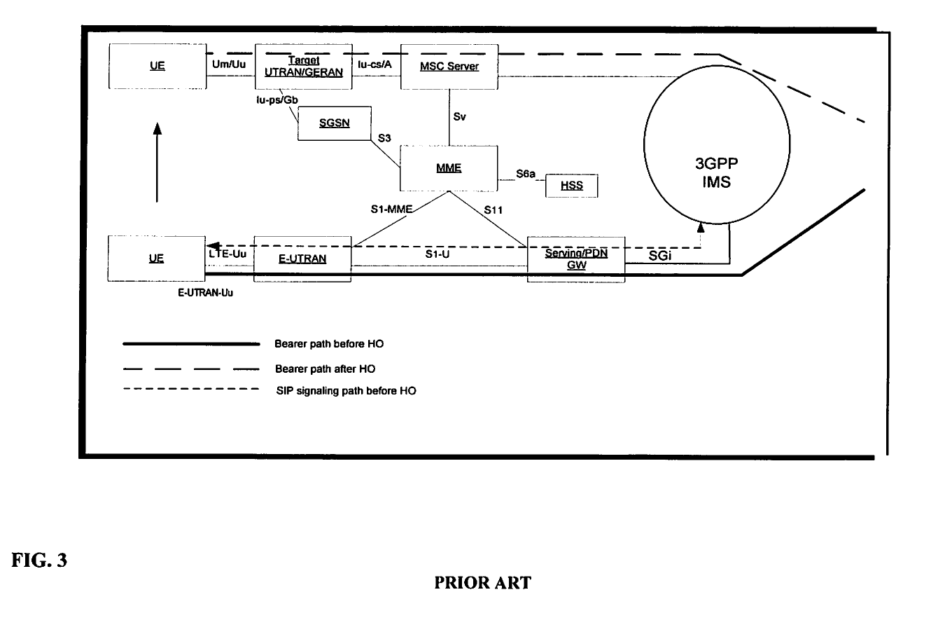

FIG. 4 illustrates the steps 400 for SRVCC from E-UTRAN to GERAN without DTM/PSHO support;

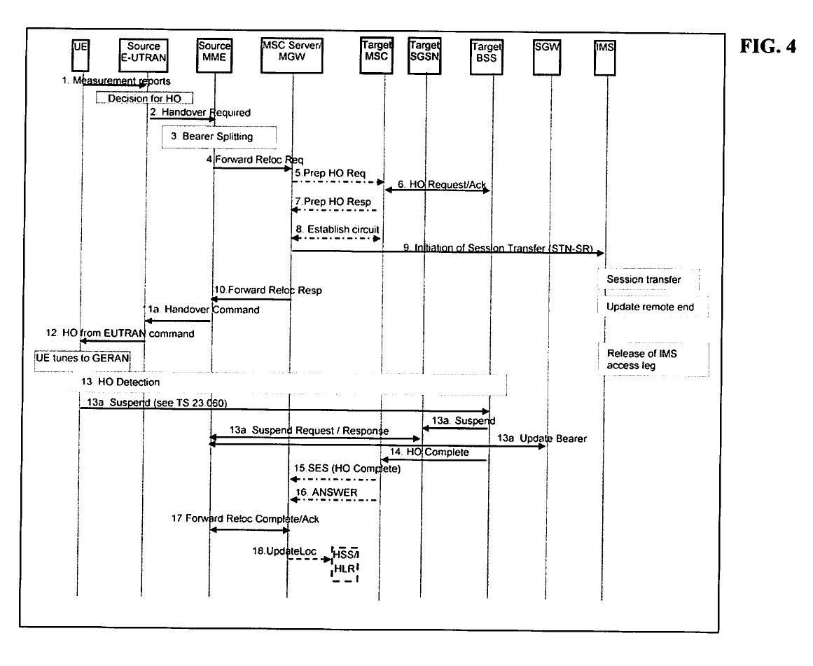

FIG. 5 illustrates an architecture for performing a first HO selection function in accordance with the teachings of the present invention;

FIG. 5a illustrates the steps of a first method of the first HO selection function in accordance with the teachings of the present invention;

FIG. 5b illustrates the steps of a second method of the first HO selection function in accordance with the teachings of the present invention;

FIG. 5c illustrates the steps of a third method of the first HO selection function in accordance with the teachings of the present invention;

FIG. 5d illustrates the steps of a fourth method of the first HO selection function in accordance with the teachings of the present invention;

FIG. 6 illustrates an architecture for performing a second HO selection function in accordance with the teachings of the present invention; and

FIG. illustrates the steps 800 of the second HO selection function in accordance with the teachings of the present invention.

### DETAILED DESCRIPTION OF THE INVENTION

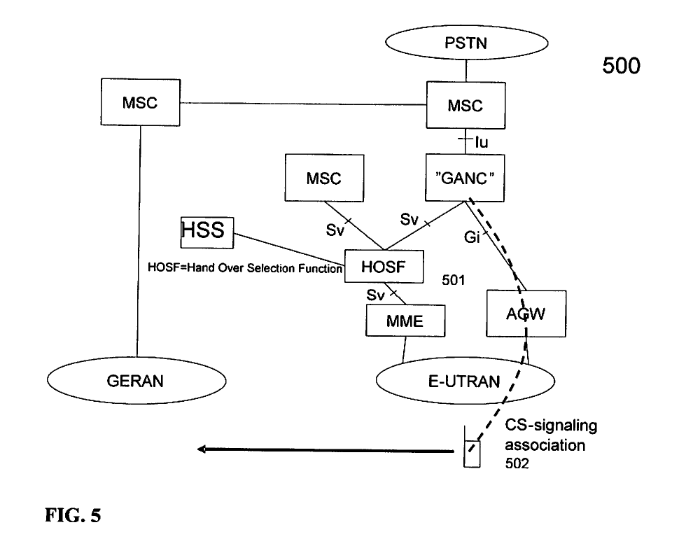

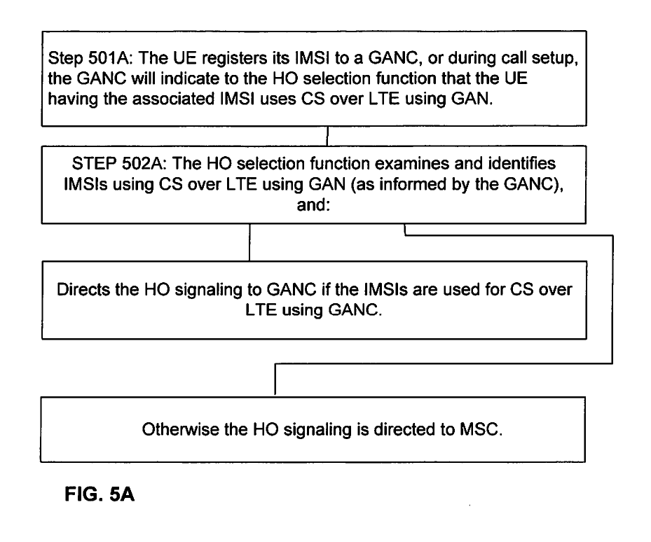

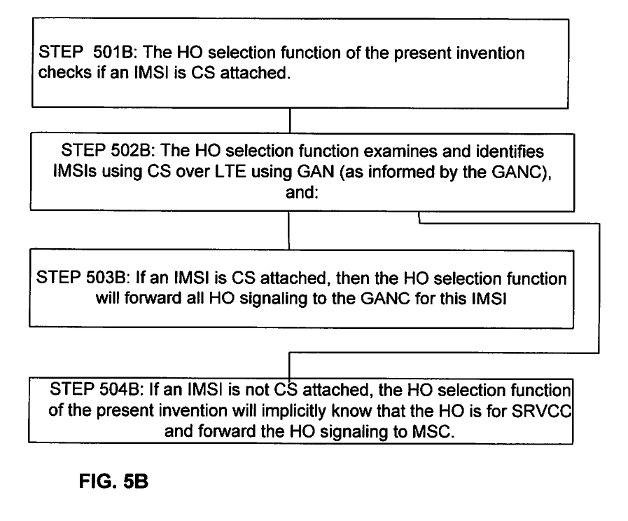

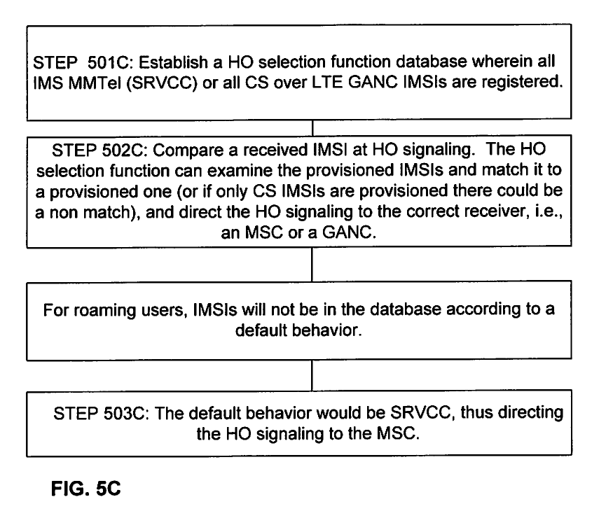

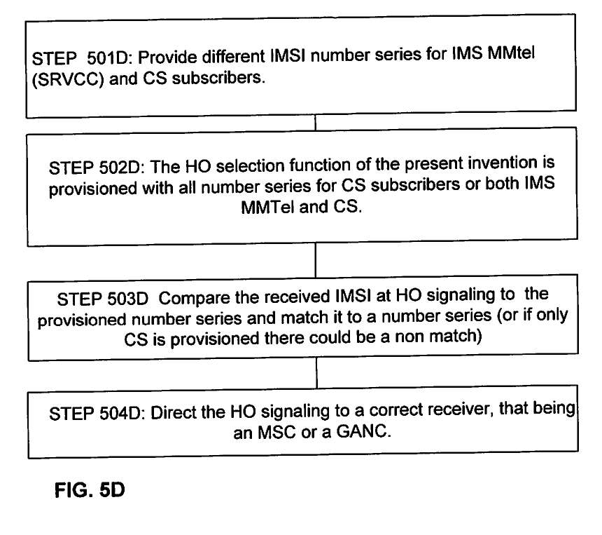

FIG. 5 illustrates an architecture 500 of a first HO selection function (HOSF) 501 in accordance with the teachings of the present invention. The HO selection function 501 of the present invention can be implemented in a software program embodied on a computer readable medium executed by computer hardware so as to perform the methods described herein.

The HO selection function 501 of the present invention examines, during HO, the IMSI of the SIM in the UE and, based on the examination, determines if the HO is related to SRVCC or if it is related to CS over LTE using GANC. There are four methods by which the HO selection function 501 of the present invention obtains information so as to determine whether a certain HO shall be directed to the GANC or the MSC. These are as described in FIGS. 5a-5d.

Referring to FIG. 5a, in step 501A, the UE registers its IMSI to a GANC, or during call setup, the GANC will indicate to the HO selection function of the present invention (501 of FIG. 5) that the UE (502 of FIG. 5) having the associated IMSI uses CS over LTE using GAN. In step 502A, the HO selection function examines and identifies IMSIs using CS over LTE using GAN (as informed by the GANC), and directs the HO signaling to GANC if the IMSIs are used for CS over LTE using GANC. Otherwise the HO signaling is directed to MSC. The present invention overcomes another problem inherent with CS over LTE using GANC—identifying the correct GANC. The HO selection function (501 of FIG. 5) of the present invention will not only hold information about an IMSI but also to which GANC the IMSI is registered. By holding this information, the HO selection function is able to direct HO signaling to a correct GANC.

Referring to FIG. 5b, in step 501B, the HO selection function of the present invention (501 of FIG. 5) checks if an IMSI is CS attached. In step 502B, when the CS HO is commenced (Forward Relocation request from MME), the HO selection function of the present invention (501 of FIG. 5) checks with the HLR to determine if an IMSI is CS attached. If an IMSI is CS attached, then the HO selection function of the present invention will forward all HO signaling to the GANC for this IMSI in step 503B. If an IMSI is not CS attached, the HO selection function of the present invention will implicitly know that the HO is for SRVCC and forward the HO signaling to MSC as seen in step 504B.

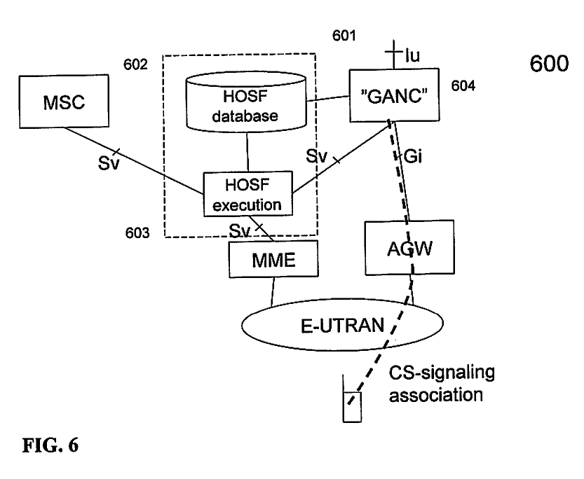

Referring to FIG. 5c, in step 501C, the HO selection function of the present invention has a database (See, for example, FIG. 6) wherein all IMS MMtel (SRVCC) or all CS over LTE GANC IMSIs are registered. By comparing a received IMSI at HO signaling in step 502C, the HO selection function of the present invention can examine the provisioned IMSIs and match it to a provisioned one (or if only CS IMSIs are provisioned there could be a non match), and direct the HO signaling to the correct receiver, i.e. an MSC or a GANC. For roaming users, IMSIs will not be in the database thus the HO selection function of the present invention would perform according to a default behavior. The default behavior would be SRVCC, thus directing the HO signaling to the MSC as seen in step 503C. In this method it is also possible to separate the execution part from the database part as seen in FIG. 6.

Referring to FIG. 5d, in step 501D, there are different IMSI number series for IMS MMtel (SRVCC) and CS subscribers. The HO selection function of the present invention is provisioned with all number series for CS subscribers or both IMS MMTel and CS in step 502D. By comparing, in step 503D, the received IMSI at HO signaling, the HO selection function of the present invention examines the provisioned number series and matches it to a number series (or if only CS is provisioned there could be a non match), and directs the HO signaling to a correct receiver, as seen in step 504D, that is to an MSC or a GANC. For roaming users, the IMSI series will not be in the database, thus the HO selection function of the present invention performs according to a default behavior. The default behavior is SRVCC, thus directing the HO signaling to the MSC.

As seen in an alternative embodiment of the present invention in FIG. 6, the HO selection function 601 of the present invention can be divided into a database part 602 and an execution part 603. In such embodiment, the GANC 604 contacts the database part 602 directly to store the information that a certain IMSI is registered. At HO signaling, the execution part 603 of the HO selection function 601 of the present invention, checks the database part 602 of an IMSI presence. The database part 602 can be a separate database or an extension to an HSS.

Regardless of the method used, the HO selection function of the present invention can be embodied in a stand alone node or it can be part of the GANC, MME or MSC. Further, as seen in FIG. 6, it can be divided in a database part and a processing part. As can be seen, the HO selection function of the present invention has the same functionality of the MME to route HO signaling to a correct MSC based on target cell identification.

An advantage of the present invention is that it facilitates the co-existence of the SRVCC and current industry initiatives to support CS voice over EPS using GANC, enabling an operator to support CS voice over EPS using GANC and IMS MMTel with SRVCC in a network at the same time.

Another advantage of the present invention is that it enables a way to find a correct GANC for the HO signaling

The present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a computer system with a computer program that, when being loaded and executed, controls the computer system such that it carries out the methods described herein.

The present invention may also be embedded in a computer program product, which comprises all the features enabling the implementation of the methods described herein, and which when loaded in a computer system and executed by a processor is able to carry out these methods. Computer program in the present context means any expression, in any language, code or notation, of a set of instructions intended to cause a system having an information processing capability to perform a particular function either directly or after either or both of the following conversion to another language, code or notation or reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed:

1. A method for determining handover (HO) signaling in a communications network, comprising the steps of:
examining the International Mobile Subscriber Identity (IMSI) of a user equipment (UE) during HO; and
based on the examination, determining whether Single Radio Voice Call Continuity (SRVCC) or circuit switched (CS) over Long Term Evolution (LTE) using a Generic Access Network Controller (GANC) shall be used in the HO.

2. The method of claim 1, as performed by a HO selection function on an Sv interface.

3. The method of claim 2, wherein the UE registers its IMSI to a GANC, or during call setup, the GANC will indicate to the HO selection function that the UE having the associated IMSI uses CS over LTE using GANC.

4. The method of claim 3, wherein the HO selection function examines and identifies IMSIs using CS over LTE using GANC, and directs the HO signaling to GANC if the IMSI uses CS over LTE using GANC, otherwise the HO signaling is directed to MSC.

5. The method of claim 4, wherein the HO selection function has stored GANC having the user's IMSI registered within, and selects said GANC for the CS over LTE using GAN handover procedure.

6. The method of claim 4, wherein the HO selection function is divided into a database part and an execution part.

7. The method of claim 2, wherein the HO selection function checks with a Home Location Register (HLR) to determine if the IMSI is CS attached.

8. The method of claim 7, wherein if the IMSI is CS attached, then the HO selection function forwards all HO signaling to the GANC and if the IMSI is not CS attached, the HO selection function forwards the HO signaling to MSC.

9. The method of claim 2, wherein the HO selection function includes a database where all SRVCC and/or all CS over LTE GANC IMSIs are registered.

10. The method of claim 9, wherein the HO selection function examines the provisioned IMSIs and matches them to a provisioned one and directs the HO signaling to the appropriate entity, either an MSC or a GANC.

11. The method of claim 2, wherein, if there are different IMSI number series for IMS and CS subscribers, the HO selection function is provisioned with all number series for CS subscribers or both IMS MMTel and CS.

12. The method of claim 11, further comprising the steps of examining the received IMSI at HO signaling;
matching it to a number series; and
directing the HO signaling to either the MSC or a GANC, as appropriate.

13. An apparatus for determining handover (HO) signaling in a communications network, comprising:
a handover selection function (HOSF) circuit having an examining means for examining the International Mobile Subscriber Identity (IMSI) of a user equipment (UE) during HO and a determination means for determining, based on the examination, whether Single Radio Voice Call Continuity (SRVCC) or circuit switched (CS) over Long Term Evolution (LTE) using a Generic Access Controller Network (GANC) shall be used in the HO.

14. The apparatus of claim 13, said HOSF circuit being coupled between a Mobility Management Entity (MME) and a GANC on an Sv interface.

15. The apparatus of claim 13, wherein said HOSF circuit is operable to intercept a GANC directed IMSI registration from the UE and receive an indication from the GANC that the UE having the associated IMSI uses CS over LTE using GANC.

16. The apparatus of claim 13, wherein said HOSF circuit is operable to receive from the GANC, the IMSI registration from the UE and receive an indication from the GANC that the UE having the associated IMSI uses CS over LTE using GANC.

17. The apparatus of claim 16, wherein the HOSF circuit is operable to examine and identify IMSI's using CS over LTE using GANC, and direct the HO signaling to the GANC if the IMSI uses CS over LTE using GANC, otherwise direct the HO signaling to the MSC.

18. The apparatus of claim 13, wherein the HOSF circuit is implemented with a database part and an execution part.

19. The apparatus of claim 13, wherein the HOSF circuit is operable to check with a Home Location Register (HLR) to determine if the IMSI is CS attached.

20. The apparatus of claim 19, wherein the HOSF circuit is operable to, if the IMSI is CS attached, forward all HO signaling to the GANC and if the IMSI is not CS attached, forward the HO signaling to MSC.

21. The apparatus of claim 13, wherein the HOSF circuit includes a database where all SRVCC and/or all CS over LTE GANC IMSIs are registered.

22. The apparatus of claim 13, wherein the HOSF circuit is operable to examine the provisioned IMSIs and match them to a provisioned one and direct the HO signaling to either an MSC or a GANC.

23. The apparatus of claim 13, wherein, if there are different IMSI number series for IMS and CS subscribers, the HOSF circuit is provisioned with all number series for CS subscribers or both IMS MMTel and CS.

24. The apparatus of claim 23, wherein the HOSF circuit is operable to examine the received IMSI at HO signaling;
match it to a number series; and
direct the HO signaling to either the MSC or a GANC, as appropriate.

25. The apparatus of claim 13, as implemented in a computer program embodied on a computer readable medium and adapted to be executed by a processor.
